(19) United States
(12) Patent Application Publication
(10) Pub. No.: US 2018/0170469 A1
(43) Pub. Date: Jun. 21, 2018

(54) POSITIONING TAILLIGHT FOR SMART CYCLING EQUIPMENT AND POSITIONING METHOD THEREOF

(71) Applicant: Shenzhen Qianhai LIVALL IoT Technology Co., Ltd., Shenzhen City (CN)

(72) Inventors: BO ZHENG, Shenzhen City (CN); YONG-ZHENG YE, Shenzhen City (CN); ZHI-MING LI, Nanchong City (CN); XIANG-LING YI, Xiamen City (CN)

(21) Appl. No.: 15/429,155

(22) Filed: Feb. 9, 2017

(30) Foreign Application Priority Data
Dec. 16, 2016 (CN) 201611170951.9

(51) Int. Cl. B62J 6/04; H04W 52/02; H04M 1/725; H04W 4/02; H04W 4/04; G01C 21/16; B62J 6/00; G01S 19/14

(52) U.S. Cl. CPC B62J 6/04; H04W 52/0225; H04M 1/7253; G01S 19/14; H04W 4/046; G01C 21/165; B62J 6/003; H04W 4/027

(57) ABSTRACT

The present disclosure relates to a positioning taillight for a smart cycling equipment and a positioning method thereof. The positioning taillight includes a main body, a GPS module, a microprocessor, an accelerometer, and a power supply; the main body includes a housing and a light emission portion; the GPS module, the microprocessor, and the accelerometer are arranged in the housing; the microprocessor is connected to the GPS module and the accelerometer; the power supply includes a first battery connected to the GPS module, the microprocessor, the accelerometer, and the light emission portion for supplying electrical energy thereto; and the GPS module is turned on to obtain the real time geographic location information according to an acceleration of the cycling equipment measured by the accelerometer.

### CROSS-REFERENCE TO RELATED APPLICATION AND CLAIM OF PRIORITY

This application claims priority of a China patent application serial No. 201611170951.9, titled “POSITIONING TAILLIGHT FOR SMART CYCLING EQUIPMENT AND POSITIONING METHOD THEREOF” and filed on Dec. 16, 2016, the contents of which are incorporated by reference herein in their entirety for all intended purposes.

### TECHNICAL FIELD

The present disclosure relates to equipment for outdoor sports, and more particularly, to a positioning taillight for a smart cycling equipment and a positioning method thereof.

### BACKGROUND

Nowadays, cycling is a popular sport allowing people to explore nature and challenge themselves. Generally, cyclists like to share a cycling path with friends by using a mobile phone. In use, a real time position of the cyclist is recorded by the mobile phone by using global positioning system (GPS) function, and the recorded positions are processed by the mobile phone to generate the cycling path. However, the mobile phone may consume a lot of power when continuously recording the real time positions, which may reduce standby time of the mobile phone rapidly, and negatively affect battery life and other application functions of the mobile phone.

### BRIEF DESCRIPTION OF THE DRAWINGS

To illustrate the technical solution according to embodiments of the present disclosure more clearly, drawings to be used in the description of the embodiments are described in brief as follows. Obviously, the drawings in the following description are merely some embodiments of the present disclosure. It is to be noted that for those ordinarily skilled in the art, other drawings can be fetched according to these drawings without doing any creative work.

FIG. 1 is a schematic view of a positioning taillight of a smart cycling equipment in accordance with a first embodiment of the present disclosure;

FIG. 2 is a schematic view showing the positioning taillight of FIG. 1 is assembled to a bicycle;

FIG. 3 is a frame diagram showing structure of the positioning taillight of FIG. 1;

FIG. 4 is a flow chart of a positioning method in accordance with a second embodiment of the present disclosure;

FIG. 5 is a flow chart of a positioning method of a positioning taillight of a smart cycling equipment in accordance with a second embodiment of the present disclosure; and

FIG. 6 is a flow chart of another exemplary positioning method of a positioning taillight of a smart cycling equipment of another in accordance with the second embodiment of the present disclosure.

### PREFERRED EMBODIMENTS

The technical solution in the embodiments of the present disclosure will be described clearly and completely accompanying with drawings of embodiments of the present disclosure as follows. Apparently, the described embodiments are only a part of the embodiments of the present disclosure, but not all the embodiments. Based on the embodiments of the present disclosure, all other embodiments achieved by those ordinarily skilled in the art without doing any creative work, should be included in the scope of the present disclosure.

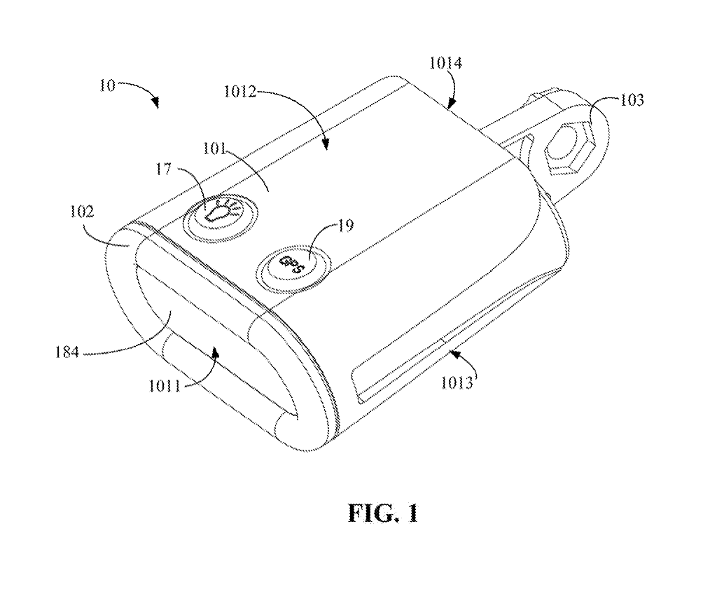

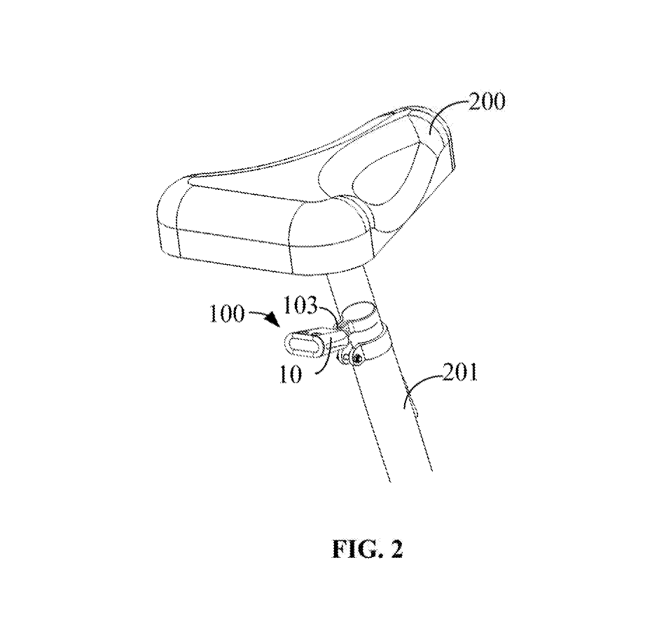

Referring to FIGS. 1 to 3, a positioning taillight 100 in accordance with a first embodiment of the present disclosure includes a main body 10, a GPS module 12, a microprocessor 14, an accelerometer 16, and a power supply 18 (see FIG. 1). In application, the positioning taillight 100 can be mounted to a cycling equipment 200, such as a bicycle, as shown in FIG. 2.

The main body 10 includes a housing 101 and a light emission portion 102. The housing 101 has a cuboid shape with roundings. The housing 101 includes a front surface 1011 and a rear surface 1014 at two ends thereof, an upper surface 1012 and a lower surface 1013. The upper surface 1012 is parallel to the lower surface 1013, and each of the upper surface 1012 and the lower surface 1013 is perpendicular to the front surface 1011 or the rear surface 1014. The light emission portion 102 is annular and in a shape of a racetrack, and is mounted to the housing 101 at the front surface 1011 thereof. The light emission portion 102 includes an annular shell (not shown) and a number of LEDs (light emitting diode) secured in the shell.

The positioning taillight 100 may further include a securement means 103. The securement means 103 is mounted to the housing 101 at the rear surface 1014 thereof. In application, the securement means 103 can be mounted to a seat post 201 of the cycling equipment 200, as shown in FIG. 2.

The GPS module 12, the microprocessor 14, and the accelerometer 16 are arranged in the housing 101. The microprocessor 14 is connected to the GPS module 12 and the accelerometer 16.

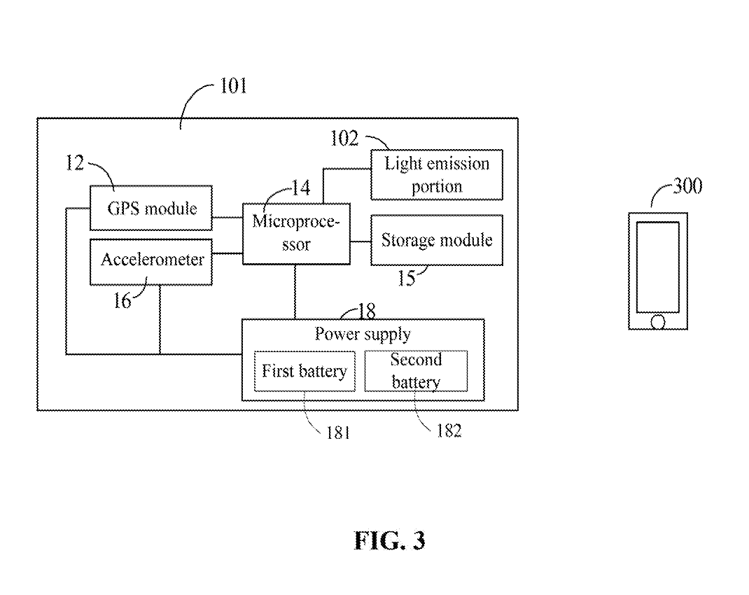

Referring to FIG. 3, the power supply 18 includes a first battery 181 connected to the GPS module 12, the microprocessor 14, the accelerometer 16, and the light emission portion 102. In use, the first battery 181 supplies power to the GPS module 12, the microprocessor 14, the accelerometer 16, and the light emission portion 102.

The first battery 181 can be a replaceable battery such as a dry cell or a button cell or a rechargeable battery such as a polymer battery. In one application, the first battery 181 is a polymer battery, and a charging interface can be defined in the lower surface 1013 or at other suitable positions. The charging interface can be a universal interface such as a Micro-USB interface which can be connected to an external power supply or an external charging device.

Preferably, referring to FIG. 3, in order to prolong the using time of the positioning taillight 100, the power supply 18 may further include a second battery 182. The second battery 182 is connected to the first battery 181 for charging the first battery 181. In the embodiment, the second battery 182 can be a solar battery. In use, the solar battery is used to generate and store electric energy when it is exposed to sunlight. In an experiment, the cycling equipment 200 is placed outdoor for half a year, it turns out that, electricity of the first battery 181 decreases 70 to 80% after half a year without the second battery 182. However, the electricity of the first battery 181 decreases only 20% after half a year by introducing the second battery 182. That is, the second battery 182 can be used to save electric energy for the first battery 181 effectively. In one application, the second battery 182 can be arranged on the front surface 1011 and surrounded by the light emission portion 102.

In this embodiment, the positioning taillight 100 may further include a light switch 17 and a GPS switch 19. The light switch 17 and the GPS switch 19 are arranged on the upper surface 1012 of the housing 101. The light switch 17 is configured for turning on and off the light emission portion 102, and the GPS switch 19 is configured for turning on and off the GPS module 12. In alternative embodiments, the light switch 17 and the GPS switch 19 can be arranged at other suitable positions of the housing 101. A cyclist can manually control the light emission portion 102 and the GPS module 12 by the light switch 17 and the GPS switch 19 during cycling.

In this embodiment, the GPS module 12 can be automatically turned on without manual operation by coopering with the accelerometer 16. In use, an acceleration of the cycling equipment 200 can be measured by the accelerometer 16, and the GPS module 12 can be automatically turned on to record real time geographic location information.

In this embodiment, the accelerometer 16 can be a three-axis accelerometer. When the cycling equipment 200 moves, the accelerometer 16 measures the acceleration of the cycling equipment 200, and generates a corresponding electrical signal to the microprocessor 14. The microprocessor 14 accordingly controls the GPS module 12 to turn on when receiving the electrical signal. In this way, a real time geographic location can be obtained by the GPS module 12. When a series of geographic locations remain unchanged, the microprocessor 14 may generate a control signal to turn off the GPS module 12.

Furthermore, the microprocessor 14 can record positions of the cycling equipment 200 in predetermined intervals (e.g., one second). A number of record positions can be processed by the microprocessor 14 to generate a cycling path of the cycling equipment 200. In use, a display screen (not shown) can be provided and connected to the cycling equipment 200. The cycling path can be displayed by the display screen. Thus, the cyclist can see the cycling path on the display screen.

In alternative embodiments, the positioning taillight 100 may further include a storage module 15 connected to the microprocessor 14 for storing the cycling path.

In this embodiment, the microprocessor 14 may include a Bluetooth chip. In use, the microprocessor 14 is wirelessly connected to a mobile phone 300 via Bluetooth. The cycling path can be transmitted to the mobile phone 300 by the microprocessor 14. In this way, the cyclist can check the real time cycling path by using the mobile phone 300.

In addition, the microprocessor 14 may process data from the accelerometer 16 and the GPS module 12, and generate cycle computer information to the mobile phone 300, showing a real time speed, a mileage, a real time altitude, and a cycling time, etc.

Preferably, the microprocessor 14 is electrically connected to the light emission portion 102. The microprocessor 14 is configured for calculating a sunrise time and a sunset time of a location according to the real time geographic location information. The real time geographic location information includes longitude and latitude information of the location and time information. The microprocessor 14 compares the time information with the sunrise time and the sunset time. When the current time is later than the sunset time but earlier than the sunrise time of the real time location, the microprocessor 14 controls the light emission portion 102 to turn on.

In application, the sunrise time of the real time location is 6:55 o'clock, and the sunset time of the real time location is 17:41 o'clock. A cyclist may probably be riding in a dark environment if the current time is 18:10 o'clock (later than the sunset time but earlier than the sunrise time). Accordingly, the microprocessor 14 generates a first control signal to turn on the light emission portion 102. In another application, the cyclist may probably be riding in a bright environment if the real time is later than the sunrise time but earlier than the sunset time. Accordingly, the microprocessor 14 generates a second control signal to turn off the light emission portion 102 when the light emission portion 102 is previously turned on. In this manner, the light emission portion 102 can be automatically turned on and off.

### Second Embodiment

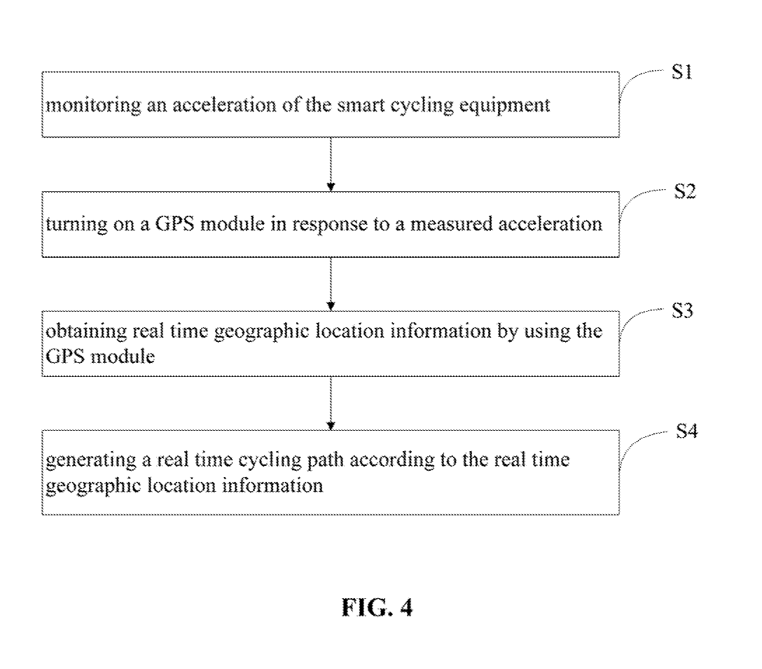

Referring to FIG. 4, a positioning method of a smart cycling equipment according to a second embodiment is provided. The positioning taillight 100 in the first embodiment is applied in the method. The method includes steps S1 to S4 as follows.

Step S1, monitoring an acceleration of a smart cycling equipment;

Step S2, turning on a GPS module in response to a measured acceleration;

Step S3, obtaining real time geographic location information by using the GPS module;

Step S4, generating a real time cycling path according to the real time geographic location information.

When the GPS module 12 is turned on, the GPS module 12 feedbacks a series of real time geographic locations. The microprocessor 14 records positions of the cycling equipment 200 in predetermined intervals (e.g., one second). A number of record positions can be processed by the microprocessor 14 to generate a cycling path of the cycling equipment 200. In use, a display screen (not shown) can be provided and connected to the cycling equipment 200. The cycling path can be displayed by the display screen. Thus, the cyclist can see the cycling path on the display screen.

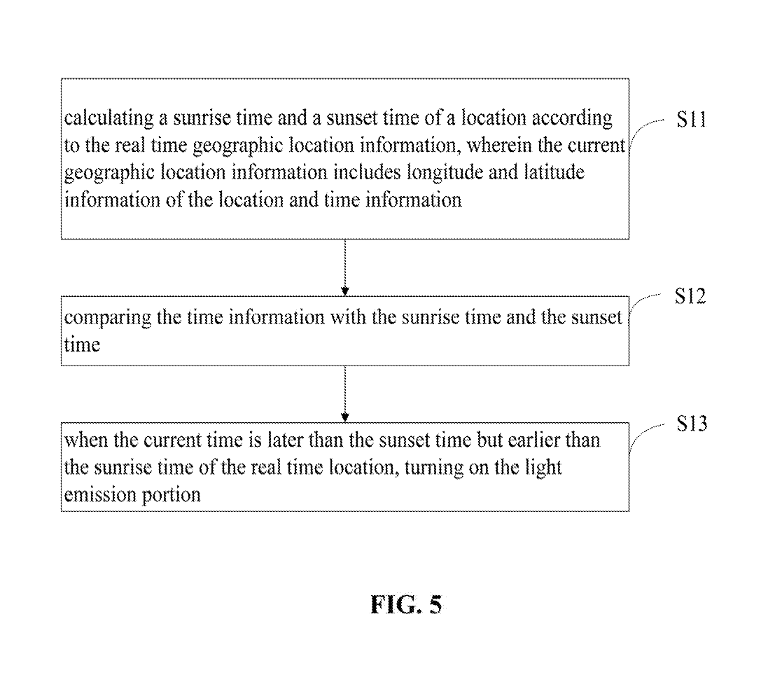

Preferably, referring to FIG. 5, in alternative embodiments, the positioning method can further include steps S11 to S13.

Step S11, calculating a sunrise time and a sunset time of a location according to the real time geographic location information, wherein the real time geographic location information includes longitude and latitude information and time information.

Step S12, comparing the time information with the sunrise time and the sunset time.

Step S13, when the current time is later than the sunset time but earlier than the sunrise time of the real time location, turning on the light emission portion.

As mentioned above, when the GPS module 12 is turned on, the GPS module 12 can obtain the real time geographic location information. In use, the GPS module 12 may further calculate the sunrise time and the sunset time according to the obtained information. In alternative embodiments, the GPS module 12 can obtain the sunrise time and the sunset time by searching an existed time table corresponding to the real time geographic location. The GPS module 12 determines whether the current time is later than the sunset time but earlier than the sunrise time. When the current time is later than the sunset time but earlier than the sunrise time, the microprocessor 14 generates a control signal to turn on the light emission portion 102.

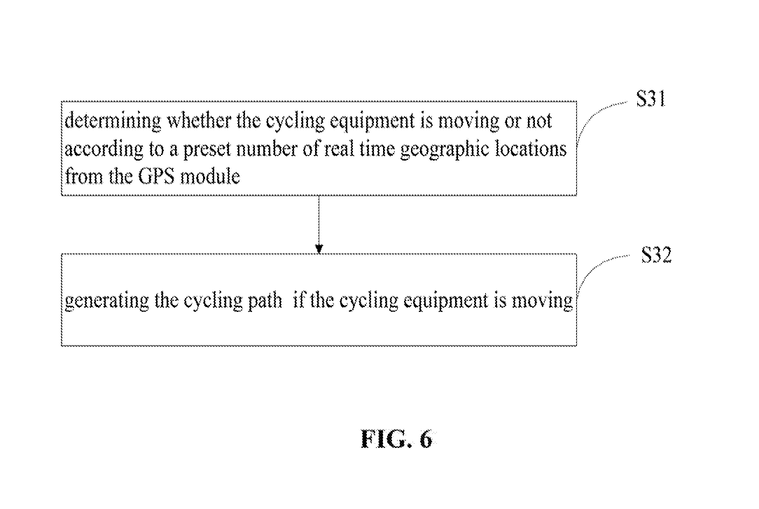

Preferably, referring to FIG. 6, in another exemplary embodiment, the positioning method may further include steps S31 and S32 between the steps S3 and S4.

Step S31, determining whether the cycling equipment is moving according to a preset number of real time geographic locations from the GPS module.

Step S32, generating the cycling path if the cycling equipment is moving.

In this embodiment, the GPS module 12 may be turned on when the cycling equipment 200 happens to shake rather than starts to move. Thus, it is necessary to determine whether the cycling equipment 200 keeps moving before a cycling path is generated. After the GPS module 12 is turned on, whether the cycling equipment is keeping moving or not can be determined according to a preset number of real time geographic locations. Supposed that the GPS module 12 feedbacks one real time geographic location every 0.1 seconds and 600 real time geographic locations are required for analysis, if the real time geographic locations remain unchanged, that is, the 600 real time geographic locations are identical. It indicates that the cycling equipment 200 does not move at all and may just happen to shake. If the real time geographic locations change, it indicates that the cycling equipment 200 is moving and thus the cycling path can be generated.

As mentioned above, in the positioning method of the positioning taillight for the smart cycling equipment provided in the above embodiments, the GPS module 12 can be automatically turned onto record the real time cycling path. Moreover, the positioning taillight 100 can be automatically turned on and thus the smart level of the cycling equipment 200 is improved.

The contents described above are only preferred embodiments of the present disclosure, but the scope of the present disclosure is not limited to the embodiments. Any ordinarily skilled in the art would make any modifications or replacements to the embodiments in the scope of the present disclosure, and these modifications or replacements should be included in the scope of the present disclosure. Thus, the scope of the present disclosure should be subjected to the claims.

1. A positioning taillight for a smart cycling equipment, wherein the positioning taillight comprises a main body, a global positioning system (GPS) module, a microprocessor, an accelerometer, and a power supply; the main body comprises a housing and a light emission portion; the GPS module, the microprocessor, and the accelerometer are arranged in the housing; the microprocessor is connected to the GPS module and the accelerometer; the power supply comprises a first battery connected to the GPS module, the microprocessor, the accelerometer, and the light emission portion for supplying electrical energy thereto; and the GPS module is turned on according to an acceleration of the smart cycling equipment measured by the accelerometer to obtain real time geographic location information; wherein the microprocessor is configured for:
calculating a sunrise time and a sunset time of a location according to the real time geographic location information, wherein the real time geographic location information comprises longitude and latitude information of the location and time information;
comparing the time information with the sunrise time and the sunset time; and
when a current time is later than the sunset time but earlier than the sunrise time, turning on the light emission portion.

2. (canceled)

3. The positioning taillight of claim 1, wherein the microprocessor generates a cycling path according to the real time geographic location information from the GPS module.

4. The positioning taillight of claim 3, wherein the smart cycling equipment further comprises a storage module connected to the microprocessor for storing the cycling path.

5. The positioning taillight of claim 4, wherein the microprocessor comprises a Bluetooth chip and is wirelessly connected to a mobile phone via Bluetooth for transmitting the cycling path to the mobile phone.

6. The positioning taillight of claim 1, wherein the microprocessor comprises a Bluetooth chip and is wirelessly connected to a mobile phone via Bluetooth; and the microprocessor generates cycle computer information according to data collected by the accelerometer and the GPS module and sends the cycle computer information to the mobile phone.

7. The positioning taillight of claim 1, wherein the first battery is a polymer battery; the power supply further comprises a second battery which is a solar battery; and the solar battery is connected to the polymer battery for charging the polymer battery.

8. A positioning method of the positioning taillight of a smart cycling equipment of claim 1, comprising:
monitoring the acceleration of the smart cycling equipment;
turning on the GPS module in response to the measured acceleration;
obtaining real time geographic location information by using the GPS module;
generating a real time cycling path of the smart cycling equipment according to the real time geographic location information;
calculating a sunrise time and a sunset time of a location according to the real time geographic location information, wherein the real time geographic location information comprises longitude and latitude information of the location and time information;
comparing the time information with the sunrise time and the sunset time; and
when a current time is later than the sunset time but earlier than the sunrise time, turning on the light emission portion.

9. (canceled)

10. The positioning method of claim 8, wherein before generating the real time cycling path of the smart cycling equipment according to the real time geographic location information, the positioning method further comprises:
determining whether the smart cycling equipment is moving or not according to a number of real time geographic locations from the GPS module; and
generating the cycling path when the smart cycling equipment is moving.
